(19) United States
(12) Patent Application Publication
(10) Pub. No.: US 2024/0228771 A9
(43) Pub. Date: Jul. 11, 2024

(54) ADDITIVE-CONTAINING BIOPOLYMER COMPOSITIONS

(71) Applicant: WACKER CHEMIE AG, Munich (DE)

(72) Inventors: Oliver Fuhrmann, Altenmarkt (DE); Manuela Lamprecht, Altenmarkt (DE); Karl Weber, Burgkirchen (DE); Angelika Weißenbacher, Kirchdorf (DE)

(73) Assignee: Wacker Chemie AG, Munich (DE)

(21) Appl. No.: 18/277,498

(22) PCT Filed: Feb. 17, 2021
(86) PCT No.: PCT/EP2021/053891

§ 371 Date: Aug. 16, 2023

(51) Int. Cl. C08L 67/04; C08L 67/02

(52) U.S. Cl. CPC C08L 67/04; C08L 67/02; C08L 2201/06; C08L 2205/03

(57) ABSTRACT

Polymer compositions and methods for producing the same. The polymer compositions include a component (A), a component (B) and a component (C). Where the component (A) is 65% to 99.4% by weight of biopolymers, the component (B) is 0.5% to 30% by weight of homopolymers, copolymers or terpolymers based on vinyl acetate and the component (C) is 0.1% to 5% by weight of organopolysiloxane pellets.

The invention relates to compositions comprising biopolymers and additives.

Biopolymers are polymers that are made entirely or partially from renewable raw materials and/or are biodegradable. They are intended to replace petroleum-based plastics. In general, the processing conditions for bioplastics are more difficult and the mechanical properties are often inadequate.

US 2017/313912 A1 discloses a composition of polylactic acid (PLA), polyvinyl acetate, and plasticizers for film applications.

US 2005/0004296 A1 describes a process for producing an organopolysiloxane pellet material and the use of the organopolysiloxane pellet material as an additive in thermoplastics.

The object was to optimize or improve the surface properties, mechanics, and processing of biopolymers through the addition of additives.

The object is achieved by the invention.

The invention provides compositions comprising
(A) 65% to 99.4% by weight, preferably 85% to 90% by weight, of biopolymers selected from the group consisting of
   polylactic acid (PLA),
   polybutylene succinate (PBS),
   polybutylene succinate adipate (PBSA),
   thermoplastic starch (TPS),
   polyhydroxyalkanoate (PHA),
   polybutylene adipate terephthalate (PBAT),
   polybutylene sebacate terephthalate (PBST),
   polyhydroxybutyrate (PHB),
   polycaprolactone (PCL),
   and cellophane (CA),
(B) 0.5% to 30% by weight, preferably 10% to 15% by weight, of homopolymers, copolymers or terpolymers based on vinyl acetate, and
(C) 0.1% to 5% by weight, preferably 1% to 2% by weight, of organopolysiloxane pellets comprising
   (1) 100 parts by weight of at least one polyorganosiloxane composed of units of general formula

RᵣSiO_{(4-r/2)}
where R is identical or different and is a substituted or unsubstituted hydrocarbon radical and r is 0, 1, 2 or 3, with the proviso that the average numerical value of r is within a range from 1.9 to 2.1,
(2) 1 to 200 parts by weight of a reinforcing or non-reinforcing filler or mixtures thereof,
(3) 0.01 to 20 parts by weight of a boric acid-containing additive for the production of the pellet material, and
(4) optionally further auxiliaries selected from the group of processing aids, plasticizers, pigments, and stabilizers,
the organopolysiloxane pellets having a particle size of 1 to 100 mm, with the proviso that the contents of components (A), (B), and (C) in % by weight are in each case based on the total weight of the compositions.

The invention also provides a process for producing the compositions by mixing
(A) 65% to 99.4% by weight, preferably 85% to 90% by weight, of biopolymers selected from the group consisting of
   polylactic acid (PLA),
   polybutylene succinate (PBS),
   polybutylene succinate adipate (PBSA),
   thermoplastic starch (TPS),
   polyhydroxyalkanoate (PHA),
   polybutylene adipate terephthalate (PBAT),
   polybutylene sebacate terephthalate (PBST),
   polyhydroxybutyrate (PHB),
   polycaprolactone (PCL),
   and cellophane (CA),
   with
(B) 0.5% to 30% by weight, preferably 10% to 15% by weight, of homopolymers, copolymers or terpolymers based on vinyl acetate, and
(C) 0.1% to 5% by weight, preferably 1% to 2% by weight, of organopolysiloxane pellets comprising
   (5) 100 parts by weight of at least one polyorganosiloxane composed of units of general formula

RᵣSiO_{(4-r/2)}
where R is identical or different and is a substituted or unsubstituted hydrocarbon radical and r is 0, 1, 2 or 3, with the proviso that the average numerical value of r is within a range from 1.9 to 2.1,
(6) 1 to 200 parts by weight of a reinforcing or non-reinforcing filler or mixtures thereof,
(7) 0.01 to 20 parts by weight of a boric acid-containing additive for the production of the pellet material, and
(8) optionally further auxiliaries selected from the group of processing aids, plasticizers, pigments, and stabilizers,
the organopolysiloxane pellets having a particle size of 1 to 100 mm, with the proviso that the contents of components (A), (B), and (C) in % by weight are in each case based on the total weight of the compositions.

The biopolymers (A) are commercially available, for example
polylactic acid (PLA) from Nature Works and Total-Corbion,
polybutylene succinate (PBS) from MCPP-Europe,
polybutylene succinate adipate (PBSA) from MCPP-Europe,
thermoplastic starch (TPS) from Rodenburg Biopolymers,
polyhydroxyalkanoate (PHA) from Biomer and Danimer Scientific,
polybutylene adipate terephthalate (PBAT) from BASF,
polybutylene sebacate terephthalate (PBST) from BASF,
polyhydroxybutyrate (PHB) from Biomer and Danimer Scientific,
polycaprolactone (PCL) from Dow-Du Pont and Perstorp,
and cellophane (CA) from FKuR.

The biopolymers employed are preferably polylactic acid (PLA) and polybutylene succinate (PBS).

The vinyl acetate-based homopolymers, copolymers or terpolymers employed as additives (B) are preferably ones selected from the group comprising vinyl acetate homopolymers,
copolymers of vinyl acetate and ethylene,
copolymers of vinyl acetate and vinyl laurate,
terpolymers of vinyl acetate, ethylene, and versatic esters,
terpolymers of vinyl acetate, ethylene, and acrylate,
terpolymers of vinyl acetate, vinyl laurate, and acrylate,
and mixtures thereof.

The vinyl acetate-based homo-, co-, and terpolymers are commercially available. For example, homo- and copolymers of vinyl acetate are commercially available under the Vinnex® trade name from Wacker Chemie AG.

The additives (B) used are preferably homopolymers of vinyl acetate and copolymers of vinyl acetate and ethylene.

The additives (B) may be in the form of fine powder (preferably having a d₅₀ of approx. 100 μm), spherical balls (preferably having a diameter of max. 2 mm), broken flakes (irregular shape) or as pellets (preferably having a diameter of up to approx. 4 mm).

The additives (C) used are organopolysiloxane pellets as described in US 2005/0004296 A1 (incorporated by reference), more particularly paragraphs [0009] to [0054].

Examples of hydrocarbon radicals R are alkyl radicals, such as the methyl, ethyl, n-propyl, isopropyl, n-butyl, isobutyl, tert-butyl, n-pentyl, isopentyl, neopentyl or tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, octadecyl radicals, such as the n-octadecyl radical; cycloalkyl radicals, such as cyclopentyl, cyclohexyl, cycloheptyl and methylcyclohexyl radicals; aryl radicals, such as phenyl, biphenyl, naphthyl, anthryl, and phenanthryl radicals; alkaryl radicals, such as o-, m- and p-tolyl radicals, xylyl radicals, and ethylphenyl radicals; and aralkyl radicals, such as the benzyl radical, α-phenylethyl radical, and β-phenylethyl radical.

Examples of substituted hydrocarbon radicals R are halogenated alkyl radicals, such as the 3-chloropropyl, 3,3,3-trifluoropropyl, and perfluorohexylethyl radical, and halogenated aryl radicals, such as the p-chlorophenyl and p-chlorobenzyl radical.

The radical R is preferably a hydrogen atom radical or a hydrocarbon radical having 1 to 8 carbon atoms, more preferably the methyl radical.

Further examples of radicals R are the vinyl, allyl, methallyl, 1-propenyl, 1-butenyl, and 1-pentenyl,
5-hexenyl, butadienyl, hexadienyl, cyclopentenyl, cyclopentadienyl, cyclohexenyl, ethynyl, propargyl, and 1-propynyl radical.

In a further preferred embodiment according to the invention, the radical R is an alkenyl radical having 2 to 8 carbon atoms, more preferably the vinyl radical.

The polyorganosiloxanes (1) are preferably highly viscous substances. Preferably, the polyorganosiloxanes (1) have a viscosity at 25° C. of from 1 000 000 to 100 000 000 mm²/s (determined in accordance with DIN 1342-2, version 2003-11).

The polyorganosiloxanes (1) are preferably diorganopolysiloxanes having trialkylsiloxy groups, trimethylsiloxy groups, dimethylhydroxysiloxy groups or dimethylvinylsiloxy groups as end groups.

The polyorganosiloxanes (1) are preferably diorganopolysiloxanes end-capped by trialkylsiloxy groups, preferably trimethylsiloxy groups and composed to an extent of 70 to 100%, preferably 90 to 100%, of dimethylsiloxane units and 0 to 30%, preferably 0 to 10%, of alkenylmethylsiloxane units, preferably vinylmethylsiloxane units.

It is possible to use a single type of polyorganosiloxane (1) or else a mixture of at least two different types of polyorganosiloxane (1).

Examples of reinforcing fillers (2) are fumed or precipitated silicas having BET surface areas of at least 50 m2/g.

The silica fillers mentioned may be hydrophilic in character or they may have been hydrophobized by known methods. They are used with preference.

Examples of non-reinforcing fillers (2) are quartz powder, diatomaceous earth, calcium silicate, zirconium silicate, zeolites, metal oxide powders such as aluminum powder, titanium powder, iron powder or zinc oxide, barium silicate, barium sulfate, calcium carbonate, gypsum, polytetrafluoroethylene powder. It is also possible to use as fillers fibrous components such as glass fibers and plastic fibers. The BET surface area of these fillers is preferably less than 50 m²/g.

The organopolysiloxane pellets according to the invention contain filler (2) in amounts of preferably 1 to 200 parts by weight, more preferably 30 to 100 parts by weight, in each case based on 100 parts by weight of polyorganosiloxane (1).

The boric acid-containing additive (3) is described in EP 1 028 140 A1, the relevant disclosure of which is intended to form part of the present application, and makes it possible to produce a completely free-flowing organopolysiloxane pellet material. The additive (3) preferably consists essentially of boric acid and water, which is preferably deionized or of higher purity, and optionally fatty acid salts, and is added to the polyorganosiloxane (1) in amounts of preferably 0.01 to 20 parts by weight, preferably 0.1 to 4 parts by weight, and more preferably 0.1 to 2 parts by weight, in each case based on 100 parts by weight of polyorganosiloxane (1).

The water serves as solvent for the boric acid and is preferably removed prior to pelletization.

The fatty acid salts optionally present in the boric acid additive (3) are preferably the salts of the metals Al, Ba, Ca, Cd, Co, Cr, Cu, Fe, Li, Mg, Mn, Ni, Pb, Sn, Sr, Zn with higher fatty acids, resin acids, and naphthenic acids, such as stearates, palmitates, oleates, linoleates, resinates, laurates, octanoates, ricinoleates, 12-hydroxystearates, naphthenates, tallates, and the like. Fatty acids having more than 12 carbon atoms up to 30 carbon atoms are preferred and fatty acids having more than 16 carbon atoms up to 26 carbon atoms particularly preferred, with particular preference given to stearates, especially calcium stearate. Fatty acid salts are present in the boric acid additive composition in amounts of preferably 0.1% to 10% by weight, preferably 0.2% to 6% by weight, more preferably 0.3% to 4% by weight.

Examples of plasticizers that can be used as component (4) in the organopolysiloxane pellet material are dipolyorganosiloxanes terminated with trimethylsiloxy groups or hydroxyl groups and having a viscosity at 25° C. of max. 5000 mm²/s or also diphenylsilanediol. The dipolyorganosiloxanes are preferably formed from dimethylsiloxane units and/or vinylmethylsiloxane units.

After the individual components (1)-(4) have been combined, preferably in a kneader, at a temperature of preferentially 100-250° C., preferably 120-200° C., the composition is pelletized with customary pelletizing means such as a perforated plate and rotating knife, affording a completely free-flowing pellet material. The resulting organopolysiloxane pellets have a particle size of 1 to 100 mm, preferably 2 to 50 mm. The organopolysiloxane pellets according to the invention preferably have a typical cylindrical pellet structure with a diameter of preferably 3 to 10 mm, more preferably 4 to 8 mm, and a height of preferably 2 to 10 mm, more preferably 3 to 8 mm. The particle size of the organopolysiloxane pellets is determined by the diameter of the perforated plate used.

Organopolysiloxane pellets used as additives (C) are commercially available for example under the Genioplast® trade name from Wacker Chemie AG.

The compositions according to the invention may in addition to constituents (A) to (C) also contain further constituents (D), such as fillers, pigments, stabilizers, and antioxidants.

The fillers used may be reinforcing or non-reinforcing fillers.

Examples of reinforcing fillers, i.e. fillers having a BET surface area of at least
50 m²/g, are fumed silica, precipitated silica or silicon-aluminum mixed oxides having a BET surface area of more than 50 m²/g. The fillers mentioned may be hydrophobized, for example by treatment with organosilanes, -silazanes or -siloxanes or by etherification of hydroxyl groups to alkoxy groups.

Examples of non-reinforcing fillers, i.e. fillers having a BET surface area of less than 50 m²/g are calcium carbonate, pulverulent quartz, cristobalite, diatomaceous earth, calcium silicate, zirconium silicate, montmorillonites such as bentonites, zeolites including molecular sieves such as sodium aluminum silicate, metal oxides such as aluminum oxide or zinc oxide or their mixed oxides, metal hydroxides such as aluminum hydroxide, barium sulfate, gypsum, silicon nitride, silicon carbide, and boron nitride.

The compositions according to the invention contain fillers in amounts of preferentially 5 to 40 percent by weight, preferably 10 to 15 percent by weight.

Suitable for the compounding of the compositions of the invention are preferably twin-screw extruders, such as commercial co-rotating twin-screw extruders. The length/diameter ratio (L/D ratio) of the screws is here preferably >30, more preferably >40.

The temperatures during the incorporation of the additives (B) and (C) into the biopolymers depends on the melting of the biopolymer. The recommended temperatures must not be exceeded here. Preference is given to using temperatures of from 170 to 220° C., preferably from 175 to 210° C., during the incorporation of the additives (A) and (B) into the biopolymers. After incorporation at elevated temperature on suitable processing equipment, the compound obtained can be processed further using conventional techniques, for example by injection molding, blow molding, compression molding or vacuum forming, in order to produce corresponding plastics.

The addition of additive (B) has the advantage of being compatible with the biopolymers, especially with polylactic acid (PLA). In addition, additive (B) permits the production of high-performance polymer blends from polylactic acid (PLA), other biopolyesters, and starch in combination with organic and inorganic fillers. The use of additives (B) in combination with PLA is particularly suitable for blown-film extrusion and injection-molding applications.

Adding additive (B) to polybutylene succinate (PBS) can significantly reduce the rate of PBS recrystallization, thereby keeping its properties constant. The flexibility or rigidity can be adjusted as required via the proportion of the selected additive type (B) and by adding polylactic acid (PLA). It is also possible to use higher proportions of organic or inorganic fillers without adversely affecting physical properties.

However, only a combination of additive (B) with additive (C) results in biopolymers having significantly better processability. Moreover, bioplastics processed using a combination of additive (B) and additive (C) show a significant improvement in surface properties and mechanical parameters over bioplastics processed only with additive (B) or only with additive (C). The combination of the two additives (B) and (C) brings about a synergistic effect here.

The use of the inventive combination of the two additives (B) and (C) in bioplastics makes it possible to produce molded parts and films having better mechanical and better surface properties than molded parts and films made from bioplastics produced using only one additive (B) or (C).

### EXAMPLES

1. Production of Compositions 1 to 18

18 compounds were compounded on a KraussMaffei Berstorff ZE-25 twin-screw extruder having a length/diameter ratio of 47 and a screw diameter of 25 mm, at a temperature of 185° C., a screw speed of 250 rpm, and a throughput of 10 kg/h. The compositions of the 18 compounds are given in the list below designated Table 1. The compounding conditions of the relevant compounds are listed in Table 2. For this, all constituents of the pellet material were mixed to form a dry blend and the dry blend was metered gravimetrically into the feed area of the extruder. Likewise, all the pulverulent constituents were mixed to form a dry blend and this dry blend was likewise metered gravimetrically into the feed area of the extruder. The resulting extrudate was pelletized with a UWG and cooled.

TABLE 1
Compositions 1 to 18

| | Composition | | | | | | | | | | | | | | | | | |
|---|---|---|---|---|---|---|---|---|---|---|---|---|---|---|---|---|---|---|
| Constituents | 1 | 2 | 3 | 4 | 5 | 6 | 7 | 8 | 9 | 10 | 11 | 12 | 13 | 14 | 15 | 16 | 17 | 18 |
| Ingeo ™ PLA | 100 | 85 | 85 | 85 | 90 | 90 | 90 | | | | | | | | 100 | 100 | | |
| 4043 D | | | | | | | | | | | | | | | | | | |
| (biopolymer A) | | | | | | | | | | | | | | | | | | |
| BioPBS ™ | | | | | | | | 100 | 90 | 90 | 90 | 90 | 90 | 90 | | | 100 | 100 |
| FZ 91 PM | | | | | | | | | | | | | | | | | | |
| (biopolymer A) | | | | | | | | | | | | | | | | | | |
| Vinnex ® | | 15 | 15 | 15 | | | | | 10 | 10 | 10 | | | | | | | |
| 2504 | | | | | | | | | | | | | | | | | | |
| (additive B) | | | | | | | | | | | | | | | | | | |
| Vinnex ® | | | | | 10 | 10 | 10 | | | | | 10 | 10 | 10 | | | | |
| 2525 | | | | | | | | | | | | | | | | | | |
| (additive B) | | | | | | | | | | | | | | | | | | |
| Genioplast ® | | | 1 | 2 | | 1 | 2 | | | | | | | | 1 | 2 | | |
| Pellet P+ | | | | | | | | | | | | | | | | | | |
| (additive C) | | | | | | | | | | | | | | | | | | |
| Genioplast ® | | | | | | | | | | 1 | 2 | | 1 | 2 | | | 1 | 2 |
| Pellet S | | | | | | | | | | | | | | | | | | |
| (additive C) | | | | | | | | | | | | | | | | | | |
| Omyacarb ® | | | | | | | | 15 | 15 | 15 | 15 | 15 | 15 | 15 | | | 15 | 15 |
| 40GU | | | | | | | | | | | | | | | | | | |
| (CaCO₃) | | | | | | | | | | | | | | | | | | |
| Total | 100 | 100 | 101 | 102 | 100 | 101 | 102 | 115 | 115 | 116 | 117 | 115 | 116 | 117 | 101 | 102 | 116 | 117 |
| [parts by | | | | | | | | | | | | | | | | | | |
| weight] | | | | | | | | | | | | | | | | | | |

Ingeo ™ PLA 4043 D Polylactic acid (PLA), trade name Ingeo ™ Biopolymer 4043 D, Nature Works
BioPBS ™ FZ 91 PM Polybutylene succinate (PBS), trade name BioPBS ™ FZ 91 PM, Mitsubishi Chemical Performance Polymers (MCPP)
Vinnex ® 2504 Vinyl acetate-ethylene copolymer, trade name Vinnex ® 2504, Wacker Chemie AG
Vinnex ® 2525 Vinyl acetate homopolymer, trade name Vinnex ® 2525, Wacker Chemie AG
Genioplast ® Pellet P+ Organopolysiloxane pellet material, trade name Genioplast ® Pellet P Plus, Wacker Chemie AG
Genioplast ® Pellet S Organopolysiloxane pellet material, trade name Genioplast ® Pellet S, Wacker Chemie AG
Omyacarb 40GU Calcium carbonate, trade name Omyacarb ® 40GU, Omya GmbH

TABLE 2
Compounding of the compositions (see 1. Production of the compositions)

| Composition | 1 | 2 | 3 | 5 | 6 |
|---|---|---|---|---|---|
| Formulation | Ingeo ™ | +15% | +15% | +10% | +10% |
| constituents | PLA | Vinnex ® 2504 | Vinnex ® | Vinnex ® 2525 | Vinnex ® |
| | 4043D | | 2504 + 1% | | 2525 + 1% |
| | | | Pellet P+ | | Pellet P+ |
| Extrusions | 185 | 185 | 185 | 185 | 185 |
| temp. [° C.] | | | | | |
| Output | 211 | 208 | 209 | 212 | 211 |
| temp. [° C.) | | | | | |
| Output | 41 | 20 | 22 | 44 | 50 |
| pressure | | | | | |
| [bar] | | | | | |
| Rotational | 57 | 53 | 52 | 59 | 62 |
| speed | | | | | |
| [%] | | | | | |
| Power | 30.7 | 29.0 | 28.5 | 32.2 | 33.6 |
| consumption | | | | | |
| [A] | | | | | |

| Composition | 8 | 9 | 10 | 12 | 13 |
|---|---|---|---|---|---|
| Formulation | BioPBS ™ | +10% | +10% | +10% | +10% |
| constituents | FZ91PM + | Vinnex ® 2504 | Vinnex ® | Vinnex ® 2525 | Vinnex ® |
| | 15% | | 2504 + 1% | | 2525 + 1% |
| | CaCO₃ | | Pellet S | | Pellet S |
| Extrusions | 200 | 200 | 200 | 200 | 200 |
| temp. [° C.] | | | | | |
| Output | 229 | 226 | 226 | 227 | 226 |
| temp. [° C.) | | | | | |
| Output | 56 | 37 | 35 | 55 | 52 |
| pressure | | | | | |
| [bar] | | | | | |
| Rotational | 65 | 60 | 59 | 51 | 49 |
| speed | | | | | |
| [%] | | | | | |
| Power | 35.4 | 32.6 | 31.8 | 27.9 | 27.0 |
| consumption | | | | | |
| [A] | | | | | |

During processing, the maximum reduction in torque and power consumption in the compounding step was experienced when using both additives.

The efficacy was determined and carried out by comparing biopolymers in which both additives (B) and (C) had been added, i.e. in which 10% or 15% by weight of Vinnex® and 1% by weight of Genioplast® had been added to the biopolymers (compositions 3 and 6 and also 10 and 13), with
the pure biopolymers without additives, both without filler (PLA, composition 1) and with filler (PBS+CaCO₃, composition 8), and with
addition to the biopolymers of additive (B) alone, such as 10% or 15% by weight of Vinnex® (compositions 2 and 5 and also 9 and 12).

2. Further Processing

2.1 Injection-Molded Plates

The compounds from Table 1 were processed on an Engel ES 600/125 injection-molding machine at 170-200° C., an injection rate of 30-80 mm/s, and a dynamic pressure of 5.4 bar into injection-molded plates having a smooth surface and dimensions of 8 cm×12 cm.

2.2 Flow Spirals

Flow spirals having a depth of 1.6 mm were also produced from the compounds on the same system at 160-190° C., an injection rate of 50 mm/s, and a back pressure of 2 bar.

2.3 Blown Films

In addition, blown films were produced to obtain test specimens.

3. Production of Test Specimens in the Form of Press Plates

Each compound was processed for 10 min at 180° C. and a pressure of 10 N/mm² into press plates of various thicknesses.

4. Examination and Evaluation of the Test Specimens

The injection-molded plates from 2.1 and press plates from 3 were stored for 2 days under standard climate conditions at 23° C. and 50% relative humidity.

4.1 COF: Sliding Property

COF in accordance with ISO 8295 Plastics—Films and sheeting—Determination of coefficients of friction

The COF is expressed without a unit and was measured using the press plates.

TABLE 3a

| COF/Formulations based on | |
|---|---|
| BioPBS ™ FZ 91 PM + 15% CaCO₃ | Kinematic |
| BioPBS ™ FZ 91 PM + | 0.56 |
| 15% CaCO₃ | |
| +10% Vinnex ® 2504 | 0.62 |
| +10% Vinnex ® 2504 + | 0.39 |
| 1% Genioplast ® Pellet S | |
| +10% Vinnex ® 2525 | 0.52 |
| +10% Vinnex ® 2525 + | 0.29 |
| 1% Genioplast ® Pellet S | |

TABLE 3b

| COF/Formulations based on | |
|---|---|
| Ingeo ™ PLA 4043 D | Kinematic |
| Ingeo ™ PLA 4043 D | 0.50 |
| +15% Vinnex ® 2504 | 0.42 |
| +15% Vinnex ® 2504 + | 0.25 |
| 1% Genioplast ® Pellet P Plus | |
| +10% Vinnex ® 2525 | 0.47 |
| +10% Vinnex ® 2525 + | 0.34 |
| 1% Genioplast ® Pellet P Plus | |

With a combination of the two additives (B) and (C) it was possible to significantly improve the sliding properties by reducing the sliding friction resistance. The coefficient of friction (CoF value) decreases. The synergistic effect of adding additives (B) and (C) can be clearly seen.

4.2 Flow Spirals

Flow spirals were produced according to 2.2.

TABLE 4a

| Flow spirals/Formulations based on | Flow path |
|---|---|
| BioPBS ™ FZ 91 PM + 15% CaCO₃ | in cm |
| BioPBS ™ FZ 91 PM + | 21.0 |
| 15% CaCO₃ | |
| +10% Vinnex ® 2504 | 27.3 |
| +10% Vinnex ® 2504 + | 28.3 |
| 1% Genioplast ® Pellet S | |
| +10% Vinnex ® 2525 | 24.1 |
| +10% Vinnex ® 2525 + | 25.6 |
| 1% Genioplast ® Pellet S | |

TABLE 4b

| Flow spiral/Formulations based on | Flow path |
|---|---|
| Ingeo ™ PLA 4043 D | in cm |
| Ingeo ™ PLA 4043 D | 21.7 |
| +15% Vinnex ® 2504 | 39.5 |
| +15% Vinnex ® 2504 + | 40.1 |
| 1% Genioplast ® Pellet P Plus | |
| +10% Vinnex ® 2525 | 23.1 |
| +10% Vinnex ® 2525 + | 24.1 |
| 1% Genioplast ® Pellet P Plus | |

Very good results were achieved with the flow spirals. Additive (B) Vinnex® significantly lengthens the flow path, while additive (C) Genioplast® provides an additional boost effect.

4.3 MFR: Melt Mass-Flow Rate

The values were determined on the pellet material in accordance with DIN EN ISO 1133.

TABLE 5

| MFI/Formulations based on | 190° C./10.0 kg |
|---|---|
| BioPBS ™ FZ 91 PM + 15% CaCO₃ | in ccm/10 min |
| BioPBS ™ FZ 91 PM + | 9.9 |
| 15% CaCO₃ | |
| +10% Vinnex ® 2504 | 36.8 |
| +10% Vinnex ® 2504 + | 38.3 |
| 1% Genioplast ® Pellet S | |
| +10% Vinnex ® 2525 | 15.5 |
| +10% Vinnex ® 2525 + | 16.9 |
| 1% Genioplast ® Pellet S | |

The melt mass-flow rate profile is improved in PBS by the addition of both additives (B) and (C).

4.4 Transparency

The transparency is evaluated visually using injection-molded plates.

The transparency of injection-molded plates is influenced by Vinnex®; with the further addition of Genioplast® there is virtually no additional cloudiness.

4.5 Ball Drop

The ball drop test is in accordance with the standard DIN EN ISO 6272-2.

Damage in Grades 1-5:

| | |
|---|---|
| 1 | No trace |
| 2 | Dent |
| 3 | Chip/crack |
| | Minimal damage |
| 4 | Chip/crack |
| | Severe damage |
| 5 | Broken through |

TABLE 6a

| Ball drop/Formulations based on | Damage in grades |
|---|---|
| BioPBS ™ FZ 91 PM + 15% CaCO₃ | 1-5 at 38 cm |
| BioPBS ™ FZ 91 PM + | 5 |
| 15% CaCO₃ | |
| +10% Vinnex ® 2504 | 3.5 |
| +10% Vinnex ® 2504 + | 3.5 |
| 1% Genioplast ® Pellet S | |
| +10% Vinnex ® 2525 | 5 |
| +10% Vinnex ® 2525 + | 2.5 |
| 1% Genioplast ® Pellet S | |

TABLE 6b

| Ball drop/Formulations based on | Damage in grades |
|---|---|
| Ingeo ™ PLA 4043 D | 1-5 at 38 cm |
| Ingeo ™ PLA 4043 D | 5 |
| +15% Vinnex ® 2504 | 2 |
| +15% Vinnex ® 2504 + | 2 |
| 1% Genioplast ® Pellet P Plus | |
| +10% Vinnex ® 2525 | 4.5 |
| +10% Vinnex ® 2525 + | 4 |
| 1% Genioplast ® Pellet P Plus | |

The ball drop test performed showed a less badly damaged surface when a combination of both additives was used.

4.6 Abrasion Test

The abrasion test was carried out in accordance with DIN 53516—Testing of rubber and elastomers: Determination of abrasion.

TABLE 7a

| Abrasion/Formulations based on | Abrasion |
|---|---|
| BioPBS ™ FZ 91 PM + 15% CaCO₃ | in mg |
| BioPBS ™ FZ 91 PM + | 117 |
| 15% CaCO₃ | |
| +10% Vinnex ® 2504 | 141 |
| +10% Vinnex ® 2504 + | 130 |
| 1% Genioplast ® Pellet S | |
| +10% Vinnex ® 2525 | 135 |
| +10% Vinnex ® 2525 + | 140 |
| 1% Genioplast ® Pellet S | |

TABLE 7b

| Abrasion/Formulations based on | Abrasion |
|---|---|
| Ingeo ™ PLA 4043 D | in mg |
| Ingeo ™ PLA 4043 D | 253 |
| +15% Vinnex ® 2504 | 381 |
| +15% Vinnex ® 2504 + | 242 |
| 1% Genioplast ® Pellet P Plus | |
| +10% Vinnex ® 2525 | 227 |
| +10% Vinnex ® 2525 + | 215 |
| 1% Genioplast ® Pellet P Plus | |

Depending on the type of Vinnex® additive (B) used, abrasion is reduced, or is even worsened as a result of greater abrasion taking place. Adding additive (C) Genioplast® not only reduces abrasion, but also compensates for the adverse effect of additive (B) on abrasion. The synergistic effect of adding additives (B) and (C) can be clearly seen.

4.7 Erichsen Scratch Test: Scratch Resistance

The Erichsen scratch test was carried out in accordance with PV3974—Scratch resistance test.

An Erichsen scratch hardness tester (model 430 P-1) was used to apply scratches to the smooth injection-molded plates from 2.1 with a force of 10 N at a speed of 1000 mm/min.

The scratches were evaluated by confocal microscopy using the light microscopy method.

TABLE 8a

| Erichsen scratch test/Formulations based | Scratch depth |
|---|---|
| on BioPBS ™ FZ 91 PM + 15% CaCO₃ | delta z in μm |
| BioPBS ™ FZ 91 PM + | 14.53 |
| 15% CaCO₃ | |
| +10% Vinnex ® 2504 | 23.11 |
| +10% Vinnex ® 2504 + | 5.46 |
| 1% Genioplast ® Pellet S | |
| +10% Vinnex ® 2525 | 12.34 |
| +10% Vinnex ® 2525 + | 5.42 |
| 1% Genioplast ® Pellet S | |

TABLE 8b

| Erichsen scratch test/Formulations based | Scratch depth |
|---|---|
| on Ingeo ™ PLA 4043 D | delta z in μm |
| Ingeo ™ PLA 4043 D | 7.15 |
| +15% Vinnex ® 2504 | 13.93 |
| +15% Vinnex ® 2504 + | 3.63 |
| 1% Genioplast ® Pellet P Plus | |
| +10% Vinnex ® 2525 | 8.5 |
| +10% Vinnex ® 2525 + | 6.59 |
| 1% Genioplast ® Pellet P Plus | |

The addition of additive (B) Vinnex® to PLA and PBS has an adverse effect on scratch depth. This can not only be compensated for by adding additive (C) Genioplast®, but significantly improved, i.e. the scratch resistance is improved. The synergistic effect of adding additives (B) and (C) can be clearly seen. In this case, a dosage of 2% by weight of Genioplast® can be recommended.

4.8 Tensile Test

The tensile test was carried out using DIN EN ISO 527 1B.

TABLE 9a

| Tensile test/Formulations based | Tensile stress at |
|---|---|
| on BioPBS ™ FZ 91 PM + 15% CaCO₃ | break in MPa |
| BioPBS ™ FZ 91 PM + | 33.8 |
| 15% CaCO₃ | |
| +10% Vinnex ® 2504 | 29.5 |
| +10% Vinnex ® 2504 + | 27.7 |
| 1% Genioplast ® Pellet S | |
| +10% Vinnex ® 2525 | 33.1 |
| +10% Vinnex ® 2525 + | 31.7 |
| 1% Genioplast ® Pellet S | |
| Tensile test/Formulations based | Elongation at |
| on BioPBS ™ FZ 91 PM + 15% CaCO₃ | break in % |
| BioPBS ™ FZ 91 PM + | 11.4 |
| 15% CaCO₃ | |
| +10% Vinnex ® 2504 | 18.3 |
| +10% Vinnex ® 2504 + | 33.7 |
| 1% Genioplast ® Pellet S | |
| +10% Vinnex ® 2525 | 16.9 |
| +10% Vinnex ® 2525 + | 18.7 |
| 1% Genioplast ® Pellet S | |

TABLE 9b

| Tensile test/Formulations based | Tensile stress at |
|---|---|
| on Ingeo ™ PLA 4043 D | break in MPa |
| Ingeo ™ 4043 D | 69.9 |
| +15% Vinnex ® 2504 | 44.7 |
| +15% Vinnex ® 2504 + | 44.2 |
| 1% Genioplast ® Pellet P Plus | |
| +10% Vinnex ® 2525 | 69.3 |
| +10% Vinnex ® 2525 + | 65.4 |
| 1% Genioplast ® Pellet P Plus | |
| Tensile test/Formulations based | Elongation at |
| on Ingeo ™ PLA 4043 D | break in % |
| Ingeo ™ 4043 D | 2.5 |
| +15% Vinnex ® 2504 | 2.2 |
| +15% Vinnex ® 2504 + | 2.2 |
| 1% Genioplast ® Pellet P Plus | |
| +10% Vinnex ® 2525 | 2.4 |
| +10% Vinnex ® 2525 + | 2.3 |
| 1% Genioplast ® Pellet P Plus | |

In the tensile test, the systems that included filler showed a significant improvement in elongation at break. A combination of additives (B) and (C), Vinnex® and Genioplast®, proved effective here.

4.9 Tear Propagation Test

The tear propagation test was carried out on the blown film with the angle specimen in accordance with DIN 53515 version 01/1990 and in accordance with Graves with an incision.

TABLE 10a

| Tear propagation test/Formulations based | Longitudinal |
|---|---|
| on BioPBS ™ FZ 91 PM + 15% CaCO₃ | Fmax in N/mm |
| BioPBS ™ FZ 91 PM + | 23.9 |
| 15% CaCO₃ | |
| +10% Vinnex ® 2525 | 20.9 |
| +10% Vinnex ® 2525 + | 28.4 |
| 1% Genioplast ® Pellet S | |
| Tear propagation test/Formulations based | Transverse |
| on BioPBS ™ FZ 91 PM + 15% CaCO₃ | Fmax in N/mm |
| BioPBS ™ FZ 91 PM + | 41.1 |
| 15% CaCO₃ | |
| +10% Vinnex ® 2525 | 25.7 |
| +10% Vinnex ® 2525 + | 28.0 |
| 1% Genioplast ® Pellet S | |

TABLE 10b

| Tear propagation test/Formulations | Longitudinal |
|---|---|
| based on Ingeo ™ PLA 4043 D | Fmax in N/mm |
| Ingeo ™ PLA 4043 D | 98.13 |
| +15% Vinnex ® 2504 | 115.0 |
| +15% Vinnex ® 2504 + | 119.7 |
| 1% Genioplast ® Pellet P Plus | |
| +10% Vinnex ® 2525 | 16.0 |
| +10% Vinnex ® 2525 + | 77.7 |
| 1% Genioplast ® Pellet P Plus | |
| Tear propagation test/Formulations | Transverse |
| based on Ingeo ™ PLA 4043 D | Fmax in N/mm |
| Ingeo ™ PLA 4043 D | 90.37 |
| +15% Vinnex ® 2504 | 114.9 |
| +15% Vinnex ® 2504 + | 102.8 |
| 1% Genioplast ® Pellet P Plus | |
| +10% Vinnex ® 2525 | 128.2 |
| +10% Vinnex ® 2525 + | 132.4 |
| 1% Genioplast ® Pellet P Plus | |

In summary, the inventive addition of additives (B) and (C) to the biopolymers led to the following advantageous results being achieved:

During processing, the maximum reduction in torque and power consumption in the compounding step was experienced when using both additives.

Sliding Property:

The coefficient of friction value is determined using a CoF measuring device. With a combination of the two additives it was possible to improve the sliding properties. The combination of the two additives (B) and (C) brings about a synergistic effect.

Flow Path:

In subsequent further processing using an injection-molding machine, additive (B) was found to significantly lengthen the flow path, additive (C) bringing an additional boost effect.

Melt Mass-Flow Rate (MFR)

The melt mass-flow rate profile is improved by the addition of additives (B) and (C) to PBS.

Transparency:

It is found that the transparency of injection-molded plates is influenced by additive (B); with the further addition of additive (C) there is virtually no additional cloudiness.

Ball Drop Test:

The ball drop test performed showed a less badly damaged surface when a combination of both additives (B) and (C) is used. More particularly, the addition of additive (C) intensifies this effect.

Abrasion Resistance:

Abrasion resistance is measured by means of a friction wheel test. Depending on the type of additive (B), abrasion is reduced, or is even increased. Adding additive (C) compensates for this effect almost completely/reduces abrasion. This applies equally to both plastic types. The combination of the two additives (B) and (C) brings about a synergistic effect.

Scratch Depth:

Adding additive (B) to PLA and PBS has an adverse effect on scratch depth. This can not only be compensated for by adding additive (C), but a significant improvement is achieved, i.e. the scratch resistance is improved, especially at a higher dosage of additive (C). The combination of the two additives (B) and (C) brings about a synergistic effect.

Tensile Test:

In the tensile test, the systems that included filler showed a significant improvement in elongation at break. A combination of additives (B) and (C) proved effective here.

The addition of the additives (B) and (C) according to the invention improves the surface properties, such as scratch resistance and abrasion resistance, the mechanics, and the processing of the bioplastics as a result of synergistic effects.

1-8. (canceled)

9. A composition, comprising:
a component (A) that is 65% to 99.4% by weight of biopolymers selected from the group consisting of
polylactic acid (PLA),
polybutylene succinate (PBS),
polybutylene succinate adipate (PBSA),
thermoplastic starch (TPS),
polyhydroxyalkanoate (PHA),
polybutylene adipate terephthalate (PBAT),
polybutylene sebacate terephthalate (PBST),
polyhydroxybutyrate (PHB),
polycaprolactone (PCL),
and cellophane (CA), and
mixtures thereof;
a component (B) that is 0.5% to 30% by weight of homopolymers, copolymers or terpolymers based on vinyl acetate; and
a component (C) that is 0.1% to 5% by weight of organopolysiloxane pellets comprising
(1) 100 parts by weight of at least one polyorganosiloxane composed of units of general formula
RᵣSiO_{(4-r/2)} (I)
where R is identical or different and is a substituted or unsubstituted hydrocarbon radical and r is 0, 1, 2 or 3, with the proviso that the average numerical value of r is within a range from 1.9 to 2.1,
(2) 1 to 200 parts by weight of a reinforcing or non-reinforcing filler or mixtures thereof,
(3) 0.01 to 20 parts by weight of a boric acid-containing additive for the production of the pellet material, and
(4) optionally further auxiliaries selected from the group of processing aids, plasticizers, pigments, and stabilizers;
wherein the organopolysiloxane pellets having a particle size of 1 to 100 mm; and
wherein the contents of components (A), (B), and (C) in % by weight are in each case based on the total weight of the compositions.

10. The composition of claim 10, wherein the vinyl acetate-based homopolymers, copolymers or terpolymers employed are ones selected from the group comprising
vinyl acetate homopolymers,
copolymers of vinyl acetate and ethylene,
copolymers of vinyl acetate and vinyl laurate,
terpolymers of vinyl acetate, ethylene, and versatic esters,
terpolymers of vinyl acetate, ethylene, and acrylate,
terpolymers of vinyl acetate, vinyl laurate, and acrylate, and
mixtures thereof.

11. The composition of claim 10, wherein the polyorganosiloxanes (1) are diorganopolysiloxanes having trialkylsiloxy groups, trimethylsiloxy groups, dimethylhydroxysiloxy groups or dimethylvinylsiloxy groups as end groups.

12. The composition of claim 10, wherein the polyorganosiloxanes (1) have a viscosity at 25° C. of from 1 000 000 to 100 000 000 mm²/s (determined in accordance with DIN 1342-2, version 2003-11).

13. A process for producing compositions, comprising:
providing components (A), (B) and (C);
wherein the component (A) is 65% to 99.4% by weight of biopolymers selected from the group consisting of
polylactic acid (PLA),
polybutylene succinate (PBS),
polybutylene succinate adipate (PBSA),
thermoplastic starch (TPS),
polyhydroxyalkanoate (PHA),
polybutylene adipate terephthalate (PBAT),
polybutylene sebacate terephthalate (PBST),
polyhydroxybutyrate (PHB),
polycaprolactone (PCL),
cellophane (CA), and
mixtures thereof,
wherein the component (B) is 0.5 to 30% by weight of homopolymers, copolymers or terpolymers based on vinyl acetate, and
wherein the component (C) is 0.1% to 5% by weight of organopolysiloxane pellets comprising
(1) 100 parts by weight of at least one polyorganosiloxane composed of units of general formula
RᵣSiO_{(4-r/2)} (I)
where R is identical or different and is a substituted or unsubstituted hydrocarbon radical and r is 0, 1, 2 or 3, with the proviso that the average numerical value of r is within a range from 1.9 to 2.1,
(2) 1 to 200 parts by weight of a reinforcing or non-reinforcing filler or mixtures thereof,
(3) 0.01 to 20 parts by weight of a boric acid-containing additive for the production of the pellet material, and
(4) optionally further auxiliaries selected from the group of processing aids, plasticizers, pigments, and stabilizers,
wherein the organopolysiloxane pellets having a particle size of 1 to 100 mm, and
wherein the contents of components (A), (B), and (C) in % by weight are in
each case based on the total weight of the compositions; and
mixing the components (A), (B) and (C) together.

14. The process of claim 13, wherein the vinyl acetate-based homopolymers, copolymers or terpolymers employed are ones selected from the group comprising
vinyl acetate homopolymers,
copolymers of vinyl acetate and ethylene,
copolymers of vinyl acetate and vinyl laurate,
terpolymers of vinyl acetate, ethylene, and versatic esters,
terpolymers of vinyl acetate, ethylene, and acrylate,
terpolymers of vinyl acetate, vinyl laurate, and acrylate, and
mixtures thereof.

15. The process of claim 13, wherein the polyorganosiloxanes (1) are diorganopolysiloxanes having trialkylsiloxy groups, trimethylsiloxy groups, dimethylhydroxysiloxy groups or dimethylvinylsiloxy groups as end groups.

16. The process of claim 13, wherein the polyorganosiloxanes (1) composed of units of formula (I) have a viscosity at 25° C. of from 1 000 000 to 100 000 000 mm²/s (determined in accordance with DIN 1342-2, version 2003-11).
